(19) United States
(12) Patent Application Publication
(10) Pub. No.: US 2005/0104326 A1
(43) Pub. Date: May 19, 2005

(54) Ball hitch system

(76) Inventors: Weldon M. Hord, Brenham, TX (US); Geraldine M. Hord, Brenham, TX (US)

Correspondence Address: Dean P. Edmundson, P.O. Box 179, Burton, TX, 77835, US

(21) Appl. No.: 10/987,916

(22) Filed: Nov. 12, 2004

Related U.S. Application Data
(60) Provisional application No. 60/523,502, filed on Nov. 19, 2003.

(51) Int. Cl. B60D 1/00

(52) U.S. Cl. 280/511

(57) ABSTRACT

A ball hitch system for towing gooseneck trailers. A ball and a shank include a longitudinal bore with a rod being vertically moveable in the bore. The lower end of the shank includes one or more pivotable cams. When the rod is in its lower position, the rod causes the cams to pivot outwardly beyond the side edges of the shank. The extending cams prevent the shank from being lifted out of a tubular sleeve which is secured to the frame of the truck being used for towing the trailer. When the gooseneck tongue is disconnected from the ball, the rod is able to be moved to a raised position, thereby enabling the cams to pivot to a retracted position. Then the ball and shank can be lifted out of the tubular sleeve for separation from the truck frame.

### CROSS-REFERENCE TO RELATED APPLICATIONS

This application is based upon, and claims priority from, Provisional Application No. 60/523,502, filed Nov. 19, 2003.

### FIELD OF THE INVENTION

This invention relates to ball hitch systems. More particularly, this invention relates to ball hitch systems for towing gooseneck trailers.

### BACKGROUND OF THE INVENTION

Gooseneck trailers are very commonly used and are typically towed by pickup trucks. The tongue of a gooseneck trailer includes a socket or coupler which fits over and onto a ball member which is secured in the bed of the towing vehicle, i.e. a pickup truck. The socket portion of the gooseneck tongue includes a clamping mechanism which secures the ball in the socket for towing purposes. The weight of the gooseneck tongue is then supported directly on the ball itself.

There are many different types of ball hitches which have been used in the past. Some types include a threaded shank which is threaded into a threaded base member secured to the truck frame. This type of ball is difficult to remove or detach from the base member. The threaded shank can become rusted in the base member, for example. Other types include a large shank which is slidably received in a tubular sleeve. The shank is then usually pinned through the sleeve to prevent the ball and shank from separating from the truck while towing. However, the use of a pin to secure the shank of the ball to the sleeve requires that the shank first be properly aligned vertically and angularly with the openings or apertures in the sleeve. Then the pin must be inserted through the registering openings in the sleeve and the shank, and the pin itself must be secured so that it will not fall out during towing.

U.S. Pat. No. 6,616,168 (Belinky) describes a releasable ball hitch in which a plurality of ball bearings in the body portion of the ball are engaged by an internal plunger that is actuated by a threaded screw that protrudes from the top of the ball. The ball bearings engage with the receiver in the hitch when the plunger is screwed down. When the plunger is screwed upward, the ball bearings are allowed to retract so that the ball can be removed from the hitch.

U.S. Pat. No. 5,871,222 (Webb) describes a detachable ball hitch in which the ball portion includes a longitudinal bore and a slot communicating with the bore. A rod is positioned in the bore and is urged upwardly with a spring. A pin is attached to the rod and is movable within the slot. The socket portion of the hitch includes a keyway for receiving the pin. After the shank portion of the ball is inserted into the socket portion, the rod is moved downwardly and rotated, whereby the pin is moved into a position where it engages the socket portion and secures the ball in place.

There has not heretofore been provided a ball hitch system having the features and advantages of the present invention.

### SUMMARY OF THE INVENTION

In accordance with the present invention there is provided an improved ball hitch system for use in towing gooseneck trailers. The ball hitch system includes a ball having a shank portion which can be inserted into many existing types of receivers found in pickup trucks. The ball can be simply lifted upwardly to remove it from the sleeve or receiver, when desired. There is no need to use tools to remove the ball or to install the ball. The socket or coupler on the lower end of the gooseneck tongue of the trailer to be towed captures the ball and prevents it from becoming accidentally separated from the sleeve or receiver in the truck during towing (even if there is no weight on the tongue).

In one embodiment of the invention there is provided a ball hitch system in which the ball includes a shank portion, with a longitudinal bore extending through the ball and the shank. An elongated rod is positioned in the bore and it is vertically movable. At the lower end of the shank there is at least one (and preferably two) cam members or lugs which are pivotably mounted. The cam members are pivotable between an extended position (where they extend outward beyond the outer edge of the shank) and a retracted position (where they do not extend outward beyond the outer edge of the shank). When the elongated rod is in a lowered or down position, the rod urges the cam member(s) to the extended position whereby the cam member(s) extends outward from the shank below the lower end of the receiver sleeve. Thus, when the cam member(s) is in the extended position, the cam member(s) prevents the ball and shank from being separated from the receiver sleeve. When the elongated rod is in a raised position, the cam member(s) can be pivoted to a retracted position to enable the ball and shank to be simply lifted out of the receiver sleeve.

Other features and advantages of the system of the invention will be apparent from the following detailed description and accompanying drawings.

### BRIEF DESCRIPTION OF THE DRAWINGS

FIG. 1 and FIG. 2 are partially cut-away views showing one embodiment of a ball hitch system of the invention;

FIG. 3 and FIG. 4 are cross-sectional views showing another embodiment of a ball hitch system of the invention;

FIG. 5 and FIG. 6 are side elevational views showing yet another embodiment of a ball hitch system of the invention;

FIG. 7 is a side elevational view of yet another embodiment of a ball hitch system of this invention with two cam members extended outwardly;

FIG. 8 is a perspective view of the ball hitch system shown in FIG. 7;

FIG. 9 is a side elevational view of the ball hitch system of FIG. 7 with the cam members in retracted position;

FIG. 10 is a perspective view of the ball hitch system shown in FIG. 9.

### DETAILED DESCRIPTION OF THE INVENTION

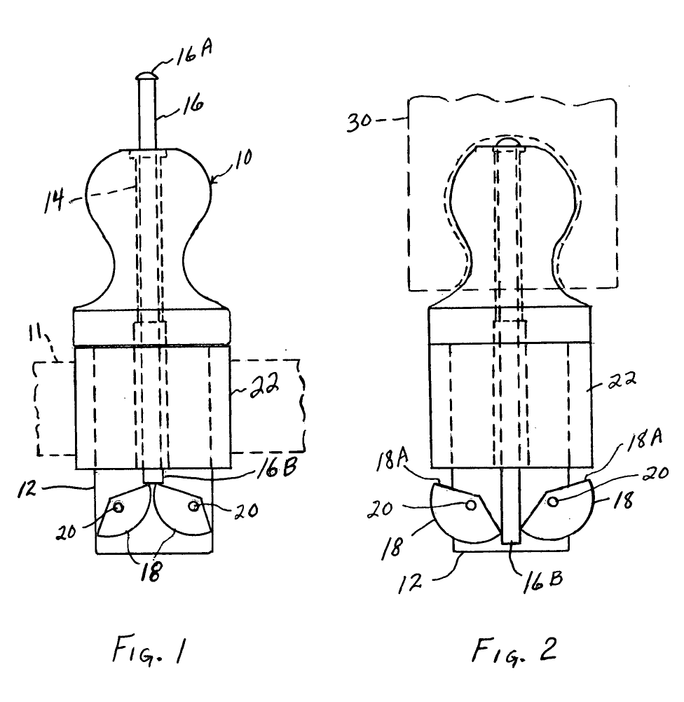

One embodiment of a ball hitch system of the invention is illustrated in FIGS. 1 and 2. The ball hitch includes a ball member 10 and a shank member 12 which is integral with the base of the ball member. The ball and the shank include a longitudinal bore 14 extending downwardly through these members. An elongated rod 16 extends downwardly through the bore 14. The rod is movable vertically in the bore and it has a sufficient length such that the lower end 16B of the rod causes the cam members 18 to pivot about pins 20 (as shown in FIG. 2) when the rod is in its lowered position. When the cam members 18 are pivoted in this manner, a portion 18A of each cam extends outwardly beyond the outer edge of the shank 12. When the cam members are extended outwardly in this manner, the shank 12 is prevented from sliding upwardly through sleeve 22 (which is secured to the frame 11 of a truck used for towing).

When the tongue of a gooseneck trailer is resting on top of the ball 10, the socket portion 30 of the tongue of the trailer pushes down on the enlarged end 16A of the rod and prevents the rod from being moved upwardly. The socket portion (sometimes called a coupler) of the gooseneck tongue captures the ball and is locked so that the ball cannot separate from the socket. Because the ball is captured in the socket, the rod 16 cannot be moved upwardly (even if there is no weight on the tongue). After the gooseneck trailer tongue has been disconnected from the ball, the rod 16 can be raised upwardly. This enables the cam members 18 to pivot freely on pins 20, thereby enabling the shank 12 to be simply lifted upwardly (along with the ball) to free it from the sleeve 22.

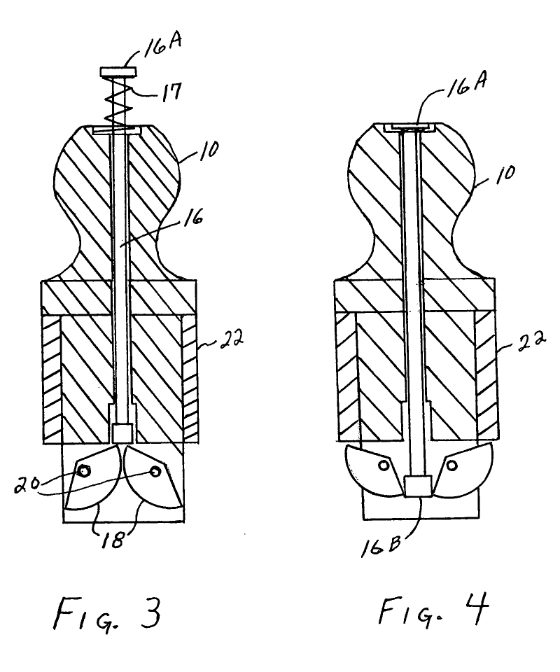

Another embodiment of a ball hitch system of the invention is illustrated in FIGS. 3 and 4. In this embodiment there is included a spring 17 (or other bias means) at the top of the ball beneath the enlarged head 16A of the elongated rod. The spring 17 urges the rod 16 upwardly as soon as the trailer tongue has been disconnected from the ball. Then the ball and its shank can be simply lifted out of the sleeve 22, when desired. Another spring can be included, if desired, on pin 20 which urges the cam member 18 to its retracted position.

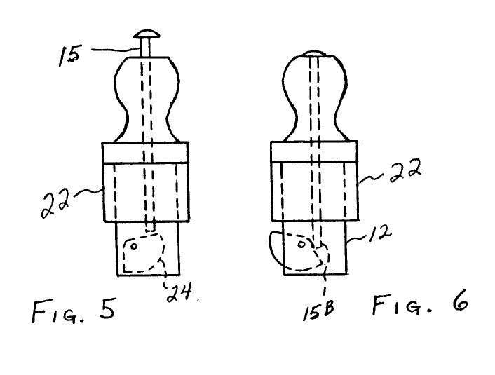

Another embodiment of a ball hitch system of the invention is illustrated in FIGS. 5 and 6. In this embodiment there is only one pivotable cam member 24. The lower end 15B of rod 15 pushes against the cam member 24 and causes it to extend beyond the outer edge of shank 12. When the rod 15 is raised, the cam 24 can pivot to its retracted position, thereby enabling the ball and shank to be simply lifted upwardly out of the sleeve 22. When a portion of the cam extends beneath the lower end of the rod 15 (as shown in FIG. 6, for example) there is no need to lift rod 15 prior to removing the shank 12 from sleeve 22. Rather, as the ball 10 is lifted upwardly, the outer portion of the cam encounters the bottom edge of sleeve 22 and the cam is therefore caused to pivot to its retracted position. This action will force the rod 15 to be raised automatically.

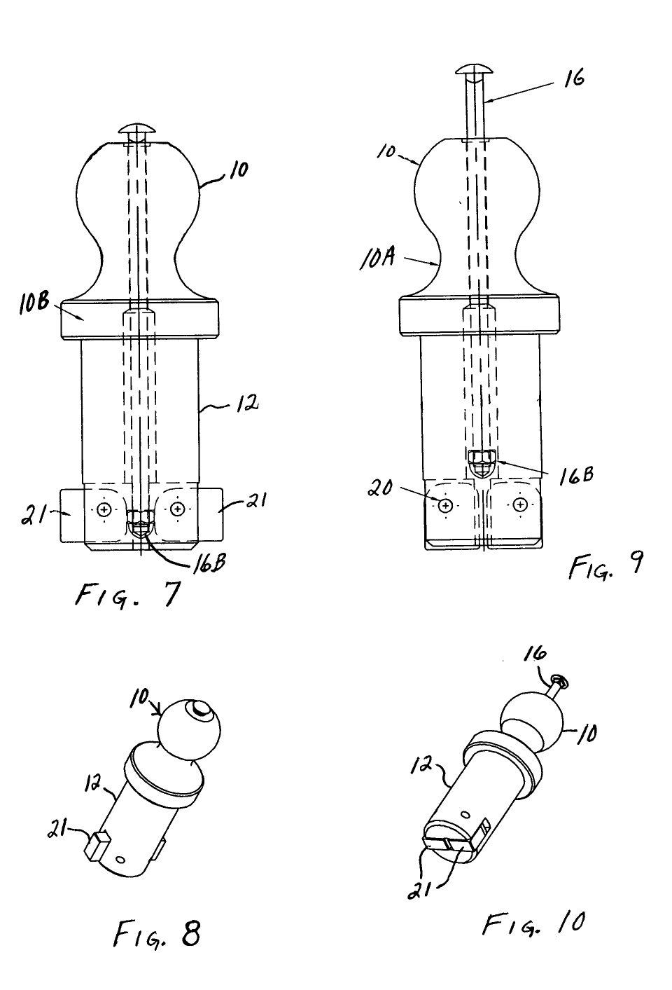

FIGS. 7, 8, 9 and 10 show another embodiment of ball hitch system of the invention which utilizes a different style of cam members 21. The ball 10 includes a neck portion 10A and an enlarged shoulder or base 10B. When the vertical rod 16 is in its lower position (FIG. 7), the lower end 16B of the rod forces the cam members 21 to pivot to their outwardly extending position. When the rod 16 is raised to its upper position, the cam members are able to pivot to their retracted position (FIG. 9).

Other variants are possible without departing from the scope of this invention. The size of the ball may vary. Also, the size and cross-sectional shape of the shank portion may vary (e.g. circular, square, hexagonal, etc.). The length of the shank may also vary. Various styles or shapes for the cam members may also be used.

1. A ball hitch system comprising a ball member and an integral shank member; wherein said ball member and shank member include a longitudinal bore; wherein an elongated rod extends downwardly through the bore and is vertically movable between raised and lowered positions; wherein said shank member further comprises at least one cam member which is pivotable between an extended position and a retracted position; wherein when said rod is in the lowered position the rod urges the cam member to its extended position to prevent the shank member from being removed from a surrounding sleeve anchored to the frame of a truck.

2. A ball hitch system for sliding engagement in a sleeve anchored to a truck frame, said system comprising a ball member and an integral shank member; wherein said ball member and said shank member include a longitudinal bore; and further comprising an elongated rod extending through said bore and being moveable between raised and lowered positions; wherein said shank member further comprises at least one cam member which is pivotable between an extended position and a retracted position; wherein when said rod is in said lowered position said rod urges said cam member to said extended position to prevent said shank member from being removed from said sleeve.

3. A ball hitch system in accordance with claim 2, wherein there are two said cam members.

4. A ball hitch system in accordance with claim 2, further comprising bias means for biasing said rod to said raised position.

5. A ball hitch system in accordance with claim 4, wherein said rod includes an upper end, and wherein said bias means is positioned between said upper end and said ball member.

6. A ball hitch system in accordance with claim 2, wherein said shank includes a lower end, and wherein said cam member is pivotably mounted to said lower end of said shank.

7. A ball hitch system in accordance with claim 6, wherein there are two said cam members, wherein said cam members are pivotably mounted on opposite sides of said shank member.

8. A ball hitch system in accordance with claim 2, wherein said rod member includes upper and lower ends; wherein said cam member includes a portion which extends beneath said lower end of said rod when said rod is in said lowered position.
